(19) United States
(12) Patent Application Publication
(10) Pub. No.: US 2010/0083002 A1
(43) Pub. Date: Apr. 1, 2010

(54) Method and System for Secure Booting Unified Extensible Firmware Interface Executables

(76) Inventors: Liang Cui, Shanghai (CN); Qin LONG, Shanghai (CN); Vincent J. Zimmer, Federal Way, WA (US); Jiewen Yao, Shanghai (CN)

Correspondence Address: Barnes & Thornburg, LLP, c/o CPA Global, P.O. Box 52050, Minneapolis, MN, 55402, US

(21) Appl. No.: 12/242,655

(22) Filed: Sep. 30, 2008

(51) Int. Cl. G06F 21/22

(52) U.S. Cl. 713/189

(57) ABSTRACT

A method and computing device for secure booting of unified extensible firmware interface executables includes generating a platform private key, signing a third party credential, storing the signed third party credential in a database located in a trusted platform module, and executing a unified extensible firmware interface executable only if an associated signed third party credential is stored in the trusted platform module.

### BACKGROUND

The UEFI Specification version 2.1, published Jan. 23, 2007 specifies a Unified Extensible Firmware Interface (UEFI) that provides a software interface between an operating system (OS) and platform firmware of a computing device. The interface defined by the UEFI specification includes data tables, which contain platform information, and boot and runtime services, which are available to the operating system (OS) loader and the operating system. The UEFI defines boot services, which include text and graphical console support on various devices, bus, block and file services, and runtime services, such as date, time and NVRAM services. Moreover, UEFI Platform Initialization Specification (PI) Version 1.0—released Oct. 31, 2006, defines the firmware interface for chipset initialization.

The open format of the Unified Extensible Firmware Interface allows platform supplier, driver authors, and other software suppliers to create application program interfaces or “protocols” for use with the Unified Extensible Firmware Interface. However, the “extensibility” of the Unified Extensible Firmware Interface also creates a larger attack surface and opportunity for the injection of malware into the platform through unprotected Unified Extensible Firmware drivers, application program interfaces, and other software.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified diagram of one embodiment of a computing device for secure booting of Unified Extensible Firmware software;

FIG. 2 is a simplified diagram of one embodiment of a method for generating a secure platform key pair;

FIG. 3 is a simplified diagram of one embodiment of a method for enrolling a third party's authentication credentials used by the system of FIG. 1;

FIG. 4 is a simplified diagram of one embodiment of a method for enrolling a third party's UEFI executable credential used by the system of FIG. 1; and

FIG. 5 is a simplified diagram of one embodiment of a secure boot method used by the system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

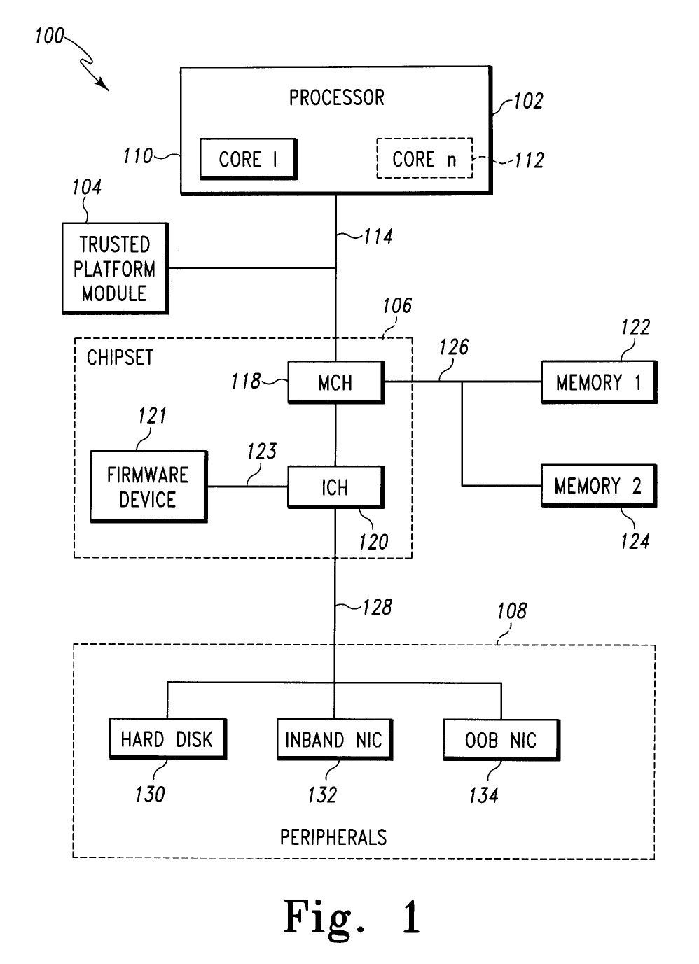

The “extensibility” of the Unified Extensible Firmware Interface (UEFI) allows platform suppliers, driver authors, and other software suppliers to create UEFI drivers, applications, and other software. A computing device 100 for securely booting or executing such UEFI software is illustrated in FIG. 1. The device 100 includes a processor 102, a trusted platform module 104, a chipset 106, and a number of peripheral devices 108. The computing device 100 may be embodied as any type of computing device such as, for example, a desktop computer system, a laptop computer system, a server or enterprise computer system, or a handheld computing device.

The processor 102 may be embodied as a single core or multi-core processor. For example, the processor 102 may include a single processor core 108 in some embodiments. Alternatively, the processor 102 may include a plurality of processor cores 110, 113. The processor 102 is communicatively coupled to the trusted platform module 104 and the chipset 106 via a number of signal paths 114. The signal paths 114 may be embodied as any type of signal paths capable of facilitating communication between the processor 102 and the trusted platform module 104 and the chipset 106. For example, the signal paths 114 may be embodied as any number of wires, printed circuit board traces, via, bus, point-to-point interconnects, intervening devices, and/or the like.

The trusted platform module 104 is a secure device configured to store cryptographic keys such as public and private keys as discussed in more detail below. In some embodiments, the trusted platform module 104 may include one or more asymmetric key pairs (i.e., a public and associated private key) stored therein during the fabrication of the module 104. For example, the key pair may be stored in firmware located on the trusted platform module 104. Alternatively, in other embodiments, the key pair may be generated and stored on the trusted platform module 104 at a time subsequent to the fabrication of the module 104 as discussed in more detail below. The trusted platform module 104 may be embodied as a substantially passive device or, alternatively, may be configured to perform some amount of processing.

The chipset 106 includes a memory controller hub (MCH) or northbridge 118, an input/output controller hub (ICH) or southbridge 120, and a firmware device 121. The firmware device 121 is communicatively coupled to the input/output controller hub 120 via a number of signal paths 123. Similar to the signal paths 116, the signal paths 123 may be embodied as any type of signal paths capable of facilitating communication between the input/output controller hub 120 and the firmware device 121 such as, for example, any number of wires, printed circuit board traces, via, bus, point-to-point interconnects, intervening devices, and/or the like. The firmware device 121 is illustratively embodied as a memory storage device for storing Basic Input/Output System (BIOS) data and/or instructions and/or other information.

The memory controller hub 118 is communicatively coupled to a number of memory devices 122, 124 via a number of signal paths 126. Again, similar to the signal paths 114, the signal paths 126 may be embodied as any type of signal paths capable of facilitating communication between the memory controller hub 118 and the memory devices 122, 124 such as, for example, any number of wires, printed circuit board traces, via, bus, point-to-point interconnects, intervening devices, and/or the like. The memory devices 122, 124 may be embodied as dynamic random access memory devices (DRAM), synchronous dynamic random access memory devices (SDRAM), double-data rate dynamic random access memory device (DDR SDRAM), and/or other volatile memory devices. Additionally, although only two memory devices are illustrated in FIG. 1, in other embodiments, the computing device 100 may include addition memory devices.

The chipset 104 is also communicatively coupled to a number of peripherals 106 via signal paths 128. Again, similar to the signal paths 116, 126, the signal paths 128 may be embodied as any type of signal paths capable of facilitating communication between the chipset 104 and the peripherals 106 such as, for example, any number of wires, printed circuit board traces, via, bus, point-to-point interconnects, intervening devices, and/or the like. The peripherals 106 may include any number of peripheral devices including data storage devices, interfaces, and output devices. For example, as illustrated in FIG. 1, the peripheral devices may include a hard disk 130, an inband network interface card (NIC) 132, and an out-of-band network interface card 134. Additionally, in other embodiments, the computing device 100 may include additional or other peripheral devices depending upon, for example, the intended use of the computing device. Further, it should be appreciated that the computing device 100 may include other components, sub-components, and devices not illustrated in FIG. 1 for clarity of the description. For example, it should be appreciated that the memory controller hub 118 may include a video controller for controlling a video display or interface and the input/output controller hub 120 may include an interrupt controller for generating interrupt events.

In use, as discussed in more detail below, the processor 102 is configured to communicate with the trusted platform module to validate and authenticate UEFI executables during the pre-OS and post-OS boot sequence. Any UEFI executable that has not been pre-authenticated or cannot be authenticated is not executed by the processor 102. The UEFI executables are authenticated via use a pair of platform keys. The platform keys are associated with the computing device 100 and define the initial root of trust for the device 100.

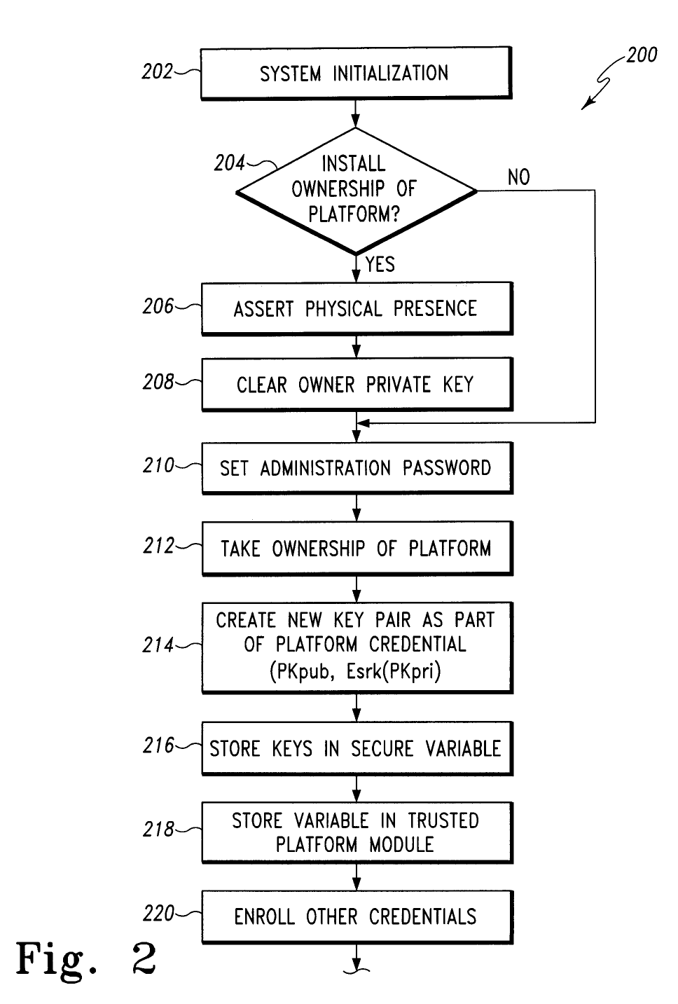

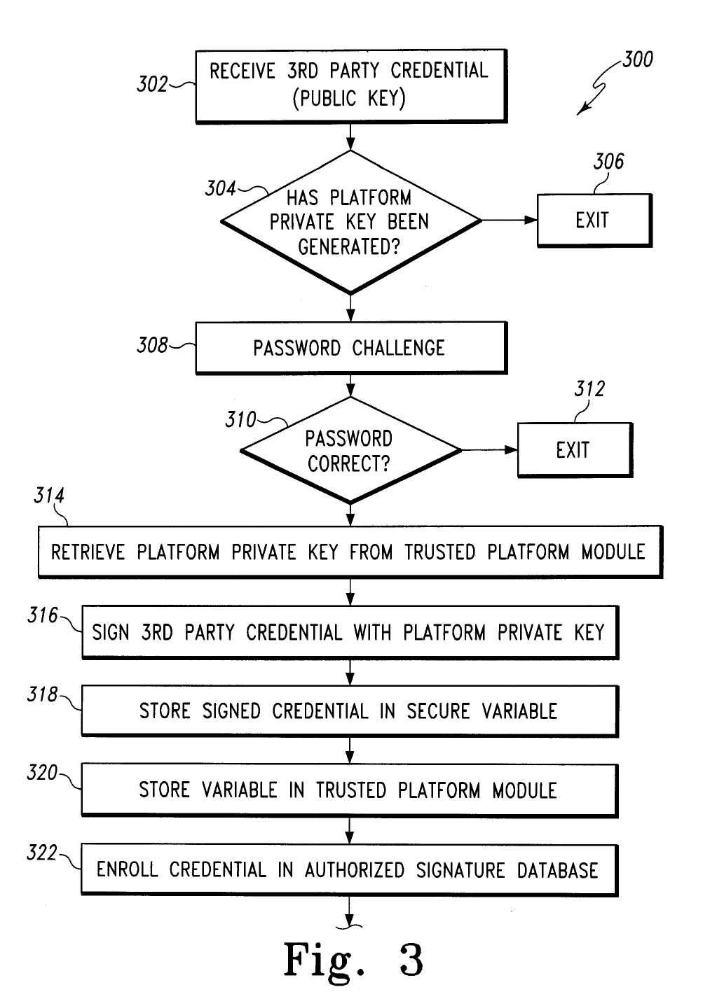

Referring now to FIG. 2, one embodiment of a method 200 for generating a pair of platform keys (i.e., a platform public key and a platform private key) beings with block 202 in which the computing device 100 performs some basic initialization including processor initialization procedures and memory-cache-initialization procedures. In block 204, the computing device 100 determines whether the platform administrator desires to install ownership of the platform (i.e., the computing device 100). If not, the method 200 advances to block 210 discussed below. However, if the platform administrator desires to install ownership, the method 200 advances to block 206 wherein the platform administrator's physical presence is asserted. The assertion of the platform administrator's physical presence may be accomplished via hardware and/or software techniques. For example, in one embodiment, the computing device 100 may include a button, switch, or other toggable device communicatively coupled to the trusted platform module 104. The platform administrator may activate the toggable device to thereby assert or verify his physical presence. Alternatively, the platform administrator's physical presence may be asserted using a software technique. In such embodiments, the trusted platform module 104 will only acknowledge the physical presence of the platform administrator during particular pre-boot periods (e.g., before the network interface cards 132, 134 are initialized).

Once the platform administrator's physical presence has been asserted in block 206, the platform private key (and public key in some embodiments) is cleared in block 208. In block 210, a new administrator's password is set. The administrator's password controls the ability of the platform administrator to generate a new set of cryptographic keys as discussed in more detail below. After the administrator password has been set, the administrator takes control of the platform (i.e., the computer device 100) in block 212.

A pair of asymmetric cryptographic platform keys is generated in block 214. The platform keys include a platform public key and a platform private key. As discussed below, the platform private key is used to endorse credentials (i.e., signatures and public keys) of third party UEFI software providers. The particular key length of the platform private and public keys, and the method used to generate such keys, may be selected based on, for example, the level of desired security. In one particular embodiment, the platform public and private keys are 1024-bit keys, but may be of greater or lesser lengths in other embodiments. Additionally, in one particular embodiment, an RSA cryptography method is used to generate the platform keys.

After the platform keys have been generated in block 214, the platform keys are stored in a secure location. To do so, in block 216, the platform private key and the platform public key are stored in a secure variable, which is subsequently stored in the trusted platform module in block 218. Other credentials, such as third party credentials, may then be enrolled in block 220.

After the platform keys have been generated, the platform private key is used to validate third party UEFI executables by enrolling the third party's credentials (e.g. the third party's public key and/or signature), which are used to authenticate the third party UEFI executable. For example, one embodiment of a method 300 for enrolling a third party's authentication credentials begins with block 302 in which the credential, such as the third party's public key, is received. The third party's public key may be used to decrypt the third party's signature or other data to ensure the authenticity of one or more third party UEFI executable.

In block 304, the computing device 100 determines if a platform private key has been generated. If not, the method 300 ends or exits in block 306. However, if a platform private key has been generated, a password challenge is conducted in block 308. The password challenge is used to ensure only the platform administer can enroll a third party's credential. In block 310, the validity of any entered password is determined. If the password is not correct, the method 300 ends or exits in block 312. However, if the password is correct, the computing device 100 retrieves the platform private key from the trusted memory module 104 in block 314.

In block 316, the third party credential (i.e., the third party public key) is signed using the platform private key. By signing the third party public key with the platform private key, the authenticity of the third party public key is being acknowledged by the computing device 100. The signed third party credential is stored in a secure variable in block 318 and the secure variable is stored in the trusted platform module 104 in block 320. In block 322, the third party credential is enrolled in an authorized signature database, which may be used to quickly and securely authenticate third party UEFI executables prior to execution as discussed in more detail below.

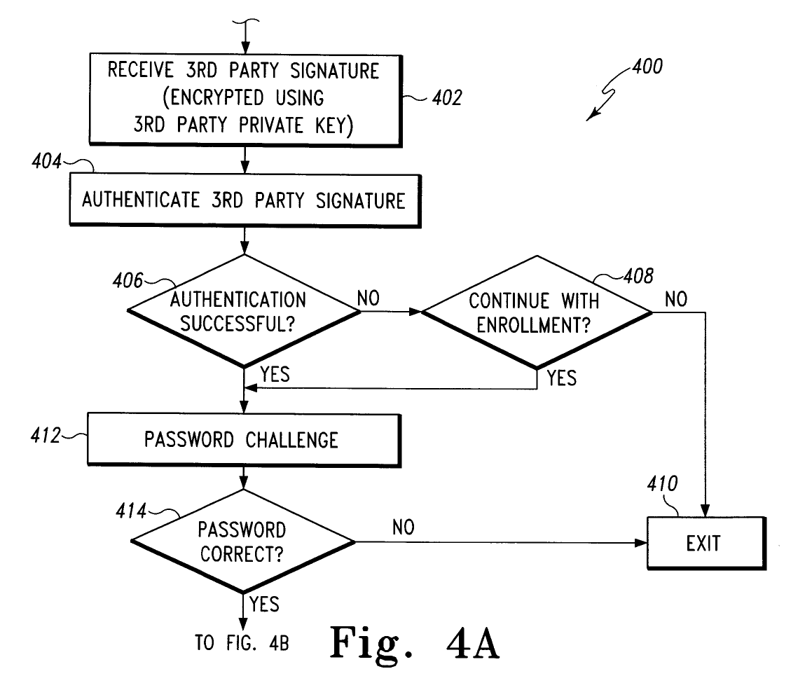

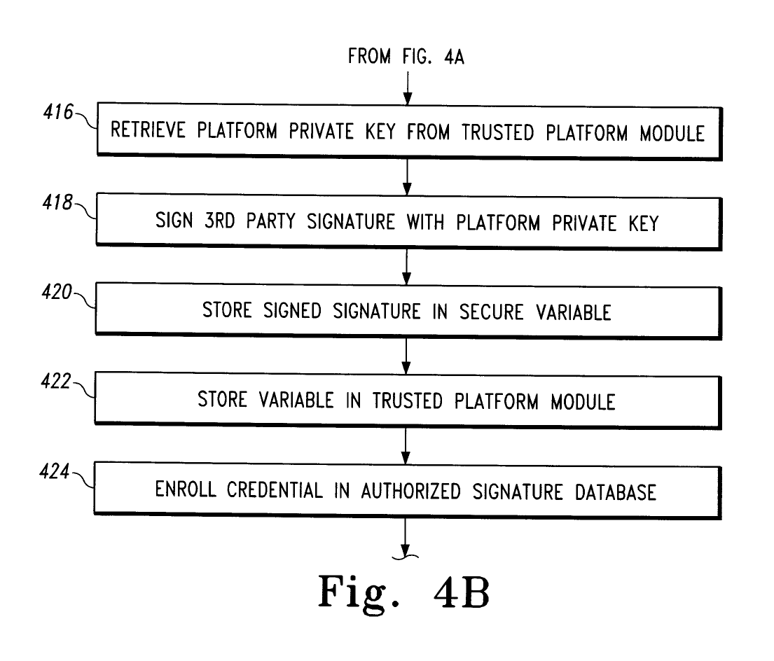

It should be appreciated that other third party credentials may be authenticated and enrolled. For example, as illustrated in FIG. 4, a method 400 for enrolling a third party's signature begins with block 402 in which the credential (i.e., the third party's signature) is received. In block 404, the third party's signature is authenticated. The third party's signature may be authenticated by decrypting the signature using the third party's public key, which may have been previously received and stored in the trusted platform module or received in conjunction with the signature. Additionally or alternatively, the third party's signature may be authenticated via use of an independent certificate authority.

In block 406, the computing device 100 determines if the authentication of the third party's signature is successful. If not, the computing device 100 determines whether the platform administrator desires to continue with the enrollment of the third party's signature regardless of the lack of authentication. If the platform administrator does not desire to continue, the method 400 ends or exits in block 410. However, if the third party's signature is authenticated or if the platform administrator desires to enroll an un-authenticated signature, the method 400 advances to block 412 in which a password challenge is conducted. The password challenge is used to ensure only the platform administer can enroll a third party's credential. In block 414, the validity of any entered password is determined. If the password is not correct, the method 400 ends or exits in block 410. However, if the password is correct, the computing device 100 retrieves the platform private key from the trusted memory module 104 in block 416.

In block 418, the third party credential (i.e., the third party signature) is signed using the platform private key. By signing the third party signature with the platform private key, the authenticity of the third party public key is being acknowledged by the computing device 100. The signed third party credential is stored in a secure variable in block 420 and the secure variable is stored in the trusted platform module 104 in block 422. In block 424, the third party credential is enrolled in an authorized signature database, which may be used to quickly and securely authenticate third party UEFI executables prior to execution as discussed in more detail below.

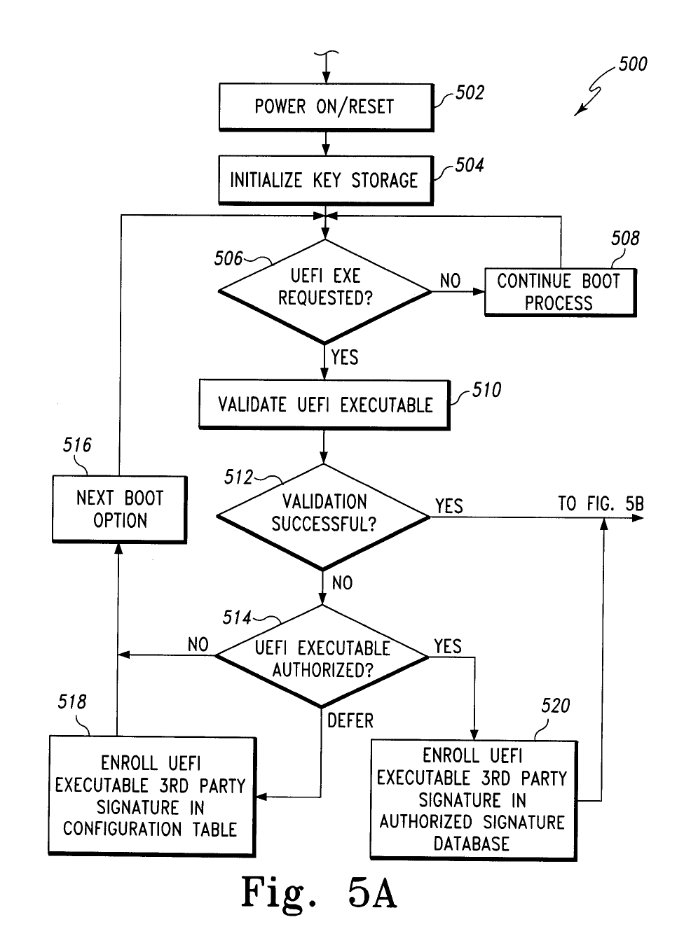

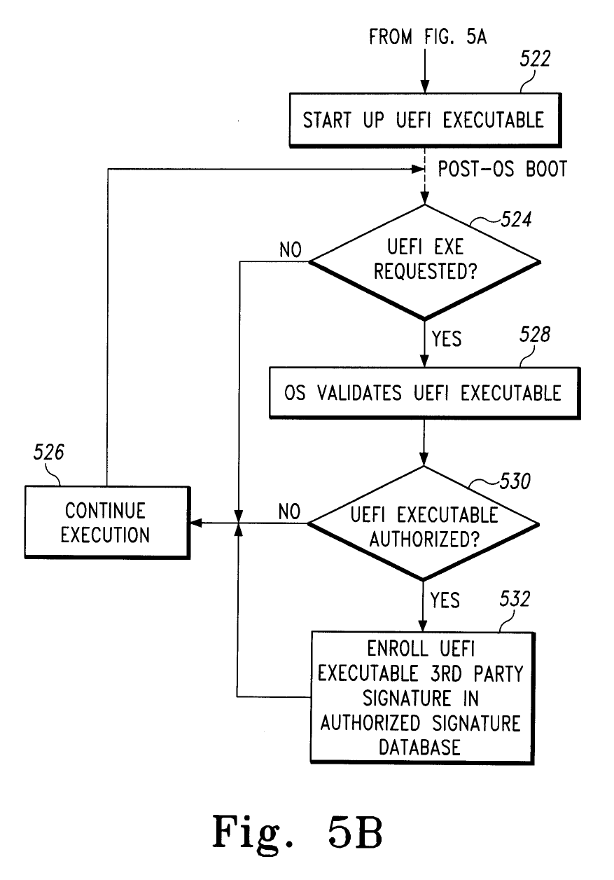

The stored authenticated and authorized third party credentials are used to securely boot the computing device 100. That is, prior to executing any UEFI executable, the authenticity of such UEFI executable is determined based, in part, on the pre-authenticated third party credentials. For example, as illustrated in FIG. 5, one embodiment of a method 500 for securely booting the computing device 100 beings with block 502 in which a power on or reset is performed. In block 504, the key storage is initialized. For example, the trusted platform module 104 and other systems may be initialized in block 504.

In block 506, the computing device 100 determines whether a UEFI executable is requested. If not, the method 500 advances to block 508 in which the boot process continues. However, if a UEFI executable is requested or otherwise required, the method 500 advances to block 510 in which the requested UEFI executable is validated prior to being executed. To do so, the computing device 100 may verify that the third party credential (e.g., the third party public key or signature) associated with the UEFI executable is stored in the authorized signature database (see, e.g., block 322 of method 300 and block 424 of method 400).

In block 512, the computing device 100 determines whether the requested UEFI executable was successfully validated in block 510. If not, the method 500 advances to block 514 in which the computing device 100 determines whether the requested UEFI executable is authorized. The computing device 100 may determine authorization of the UEFI executable using a method similar to the methods 300, 400 described above. For example, the computing device 100 may authenticate a third party signature associated with the UEFI executable as discussed above in regard to block 404 of method 400. If the UEFI executable is not authorized, the method 500 advances to block 516 in which the next boot option is performed. Alternatively, if the authorization cannot be determined or is required to be determined later, the authorization of the UEFI executable may be deferred. If so, the method 500 advances to block 518 in which the third party signature associated with the executable is enrolled in a configuration table for later authorization using, for example, the method 400. If, however, the UEFI executable is authorized in block 514, the method 500 advances to block 520 in which the third party signature of the UEFI executable is enrolled in the authorized signature databases similar to the block 322 of method 300 and the block 424 of method 400.

If the UEFI executable is validated in block 512 or is otherwise authorized in block 514 (and enrolled in block 520), the method 500 advances to block 522. In block 522, the computing device 100 executes the requested UEFI executable and subsequently continues the pre-operating system boot process. After the operating system has been booted, additional UEFI executables may be requested as shown in block 524. If so, the operating system validates the requested UEFI executable in block 518. The validation process may be substantially similar to the validation process described above in regard to block 510. In block 520, the computing device determines whether the validation was successful. If not, the operating system continues execution in block 526. However, if the UEFI executable is validated, the UEFI executable is started, and the associated third party signature is enrolled in the authorized signature database if already enrolled, in block 532. The operating system subsequently continues execution in block 526.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method comprising:
generating a platform private key on a computing device, the platform private key identifying the computing device;
receiving a third party credential, the third party credential identifying the third party;
signing the third party credential using the platform private key;
storing the signed third party credential in a database located in a trusted platform module; and
executing a unified extensible firmware interface executable only if a signed third party credential associated with the unified extensible firmware interface executable is stored in the database.

2. The method of claim 1, wherein receiving a third party credential comprises receiving a third party public key.

3. The method of claim 1, wherein receiving a third party credential comprises receiving a third party digital signature certificate.

4. The method of claim 3, wherein the third party digital signature certificate comprises a third party public key and third party data that has been encrypted with a third party private key.

5. The method of claim 4, further comprising authenticating the third party digital signature by decrypting the third party data using the third party public key.

6. The method of claim 1, wherein signing the third party credential comprises encrypting the third party credential using the private key.

7. The method of claim 6, further comprising:
(i) generating a platform public key;
(ii) retrieving the signed third party credential from the database; and
(iii) decrypting the third party credential using the platform public key.

8. The method of claim 1, wherein executing a unified extensible firmware interface executable comprises searching the database for a signed third party credential that authenticates the unified extensible firmware interface executable.

9. The method of claim 1, further comprising storing the platform private key in a trusted platform module of the computing device.

10. The method of claim 1, further comprising authenticating the third party credential using a third party public key associated with the third party credential.

11. A machine readable medium comprising a plurality of instructions, that in response to being executed, result in a computing device:
verifying the physical presence of a platform administrator of a computing device;
prompting for the entering of a password if the physical presence of the platform administrator is verified;
clearing a platform public key and a platform private key of the computing device if the password is correct, the platform private key identifying the computing device;
generating a new platform public key and a new platform private key; and
storing the new platform public key and the new platform private key in a trusted platform module of the computing device.

12. The machine readable medium of claim 11, wherein the plurality of instructions further result in the computing device signing a third party credential using the new platform private key.

13. The machine readable medium of claim 12, wherein the plurality of instructions further result in the computing device signing the third party credential comprises retrieving the new platform private key from the trusted platform module.

14. The machine readable medium of claim 12, wherein the plurality of instructions further result in the computing device storing the signed third party credential in a database stored in the trusted platform.

15. The machine readable medium of claim 14, wherein the plurality of instructions further result in the computing device:
(i) receiving a request for execution of a unified extensible firmware interface executable;
(ii) accessing the database to determine whether a signed third party credential associated with the unified extensible firmware interface executable is stored therein; and
(iii) executing the unified extensible firmware interface executable only if the signed third party credential associated with the unified extensible firmware interface executable is located in the database.

16. The machine readable medium of claim 15, wherein the plurality of instructions further result in the computing device executing the unified extensible firmware interface executable comprises retrieving the signed third party credential associated with the unified extensible firmware interface executable from the database.

17. The machine readable medium of claim 16, wherein the plurality of instructions further result in the computing device executing the unified extensible firmware interface executable comprises decryption the signed third party credential using the platform public key.

18. A computing device comprising:
a processor;
a trusted platform module; and
a memory device having stored therein a plurality of instructions, which when executed by the processor, cause the processor to:
generate a platform private key on a computing device, the private key identifying the computing device;
sign a third party credential using the platform private key;
store the signed third party credential in a database located in a trusted platform module; and
execute a unified extensible firmware interface executable only if a signed third party credential associated with the unified extensible firmware interface executable is located in the database.

19. The computing device of claim 18, wherein the plurality of instructions, when executed by the processor, further cause the processor to retrieve the signed third party credential associated with the unified extensible firmware interface from the database and decrypt the signed third party credential using a platform public key associated with the computing device.

20. The computing device of claim 20, wherein the third party credential comprises a third party digital signature certificate including a third party public key and third party data that has been encrypted with a third party private key.
